(19) United States
(12) Patent Application Publication
(10) Pub. No.: US 2022/0114010 A1
(43) Pub. Date: Apr. 14, 2022

(54) COOPERATIVE MANAGEMENT OF DYNAMIC EDGE EXECUTION

(71) Applicants: Francesc Guim Bernat, Barcelona (ES); Srikathyayani Srikanteswara, Portland, OR (US); Karthik Kumar, Chandler, AZ (US); Alexander Bachmutsky, Sunnyvale, CA (US)

(72) Inventors: Francesc Guim Bernat, Barcelona (ES); Srikathyayani Srikanteswara, Portland, OR (US); Karthik Kumar, Chandler, AZ (US); Alexander Bachmutsky, Sunnyvale, CA (US)

(21) Appl. No.: 17/559,318

(22) Filed: Dec. 22, 2021

(51) Int. Cl. G06F 9/455; G06F 9/48; G06F 9/50

(52) U.S. Cl. CPC G06F 9/45558; G06F 9/4893; G06F 2009/45595; G06F 9/5094; G06F 2009/4557; G06F 9/5077

(57) ABSTRACT

Various aspects of methods, systems, and use cases include dynamic edge scheduling at an edge device of a system of edge devices. An edge device may include processing circuitry to execute instructions including operations to determine a set of capabilities and constraints of each of a plurality of remote edge devices. The operations may include determining candidate remote edge devices from the plurality of remote edge devices based on function requirements for a function and the set of capabilities and constraints. The operations may include selecting, from the candidate remote edge devices, a remote edge device to execute the function based on a power efficiency for the system determined using the set of capabilities and constraints.

### BACKGROUND

Edge computing, at a general level, refers to the implementation, coordination, and use of computing and resources at locations closer to the “edge” or collection of “edges” of the network. The purpose of this arrangement is to improve total cost of ownership, reduce application and network latency, reduce network backhaul traffic and associated energy consumption, improve service capabilities, and improve compliance with security or data privacy requirements (especially as compared to conventional cloud computing). Components that can perform edge computing operations (“edge nodes”) can reside in whatever location needed by the system architecture or ad hoc service (e.g., in an high performance compute data center or cloud installation; a designated edge node server, an enterprise server, a roadside server, a telecom central office; or a local or peer at-the-edge device being served consuming edge services).

Applications that have been adapted for edge computing include but are not limited to virtualization of traditional network functions (e.g., to operate telecommunications or Internet services) and the introduction of next-generation features and services (e.g., to support 5G network services). Use-cases which are projected to extensively utilize edge computing include connected self-driving cars, surveillance, Internet of Things (IoT) device data analytics, video encoding and analytics, location aware services, device sensing in Smart Cities, among many other network and compute intensive services.

Edge computing may, in some scenarios, offer or host a cloud-like distributed service, to offer orchestration and management for applications and coordinated service instances among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an overview of an edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates deployment of a virtual edge configuration in an edge computing system operated among multiple edge nodes and multiple tenants.

FIG. 5 illustrates various compute arrangements deploying containers in an edge computing system.

FIG. 6 illustrates a compute and communication use case involving mobile access to applications in an edge computing system.

FIG. 7A provides an overview of example components for compute deployed at a compute node in an edge computing system.

FIG. 7B provides a further overview of example components within a computing device in an edge computing system.

FIG. 8 illustrates a renewable energy powered edge appliance device in accordance with some embodiments.

FIG. 9 illustrates an example system block diagram in accordance with some embodiments.

FIG. 10 illustrates an example multicast diagram in accordance with some embodiments.

FIG. 11 illustrates a flowchart showing a technique for dynamic edge scheduling in accordance with some embodiments.

### DETAILED DESCRIPTION

Systems and techniques described herein include dynamic edge scheduling among edge devices in a system. The system may include edge devices that are remote from a power grid or network (e.g., wirelessly connected, solar powered, etc.). The system of edge devices may include a limited number of edge devices (e.g., one) that is wired to a network or has access to a power grid, in some examples. The edge devices of the system may have access to a power grid for some use or in emergencies, but may primarily rely on a renewable power source. The edge devices in the system may work together collaboratively, such as by using peer-to-peer communication, to schedule functions to execute using services, microservices, or resources of the system. The collaborative process may include minimizing or reducing a metric system-wide. For example, the collaborative process may include minimizing total power usage on the system, minimizing total battery usage in the system, minimizing system compute usage, or the like.

In an example, the systems and techniques described herein include coordination and collaboration among solar energy (or other green) powered edge devices, such as with no cables connecting to any backhaul (e.g., no wired grid, no wired network, etc.). These renewable powered edge devices may be powered with a battery supply that is recharged with the renewable power. In some examples, one or more edge devices with a network or grid connection may act as a connector via peer to peer to the other renewable powered edge devices in the local edge network.

A local edge network may include a geographic area, such as all edge devices within a few kilometers. The edge devices in a local edge network, which may also be called a hive or a system, may have different energy profiles, such as having different levels of power supply (e.g., availability of sunlight, availability of wind, etc.) or power availability (e.g., battery charge) throughout a time period, such as a day. As functions are identified for scheduling throughout the time period, edge devices in the local edge network may coordinate to schedule the functions based on the power supply or power availability. The local edge network may include dynamic edge scheduling based on available or foreseeable power, latency constraints, bandwidth, microservice execution capability, etc.

The functions that are to be scheduled may be performed using a service or a microservice of an edge device. For example, a main service executed in one base station may be used to coordinate or execution portions of functions to be scheduled, with one or more different microservices. In some examples, the main service may use an interconnect processing unit (IPU) for a microservice. The edge device may determine whether the requested function is to be executed in the microservice instance in the edge device, or if it is to be sent to a peer edge device that may provide the microservice. The determination may include using a latency of the destination edge device, hardware or software capabilities of the destination edge device, a number of hops from the edge device to the destination edge device, power availability or use at the destination edge device, bandwidth of the network (e.g., including intermediate edge devices for hops to the destination edge device), or the like. An overall system-wide determination for optimization of one or more parameters (e.g., power usage, bandwidth, etc.) may be used for selection of a destination edge device for executing a function at a microservice.

An edge device may use a discovery mechanism, such as via a simple network management protocol (SNMP) to discover peers, or the peers may be specified (e.g., by an orchestrator). The edge device may use a discovery protocol to identify other edge devices and connect, authenticate, and exchange capabilities with these nearby edge devices stations. In some examples, microservice or power availability at peer devices may be updated, such as every day, every minute, every second, or the like. Telemetry data for microservices launched or available or power available or predicted may be provided periodically. In another example, a publish/subscription service may be used. For example, when a peer updates CPU availability, network availability, microservices instantiated, power availability, etc., it may publish an update. An IPU of an edge device in the network may subscribe and receive the published updates from the nearby peer. In some examples, such as for power or battery availability or capacity, an edge device may fetch the information via a publish/subscribe protocol, such as MQTT protocol, data distribution service (DDS), or an M2M communication protocol.

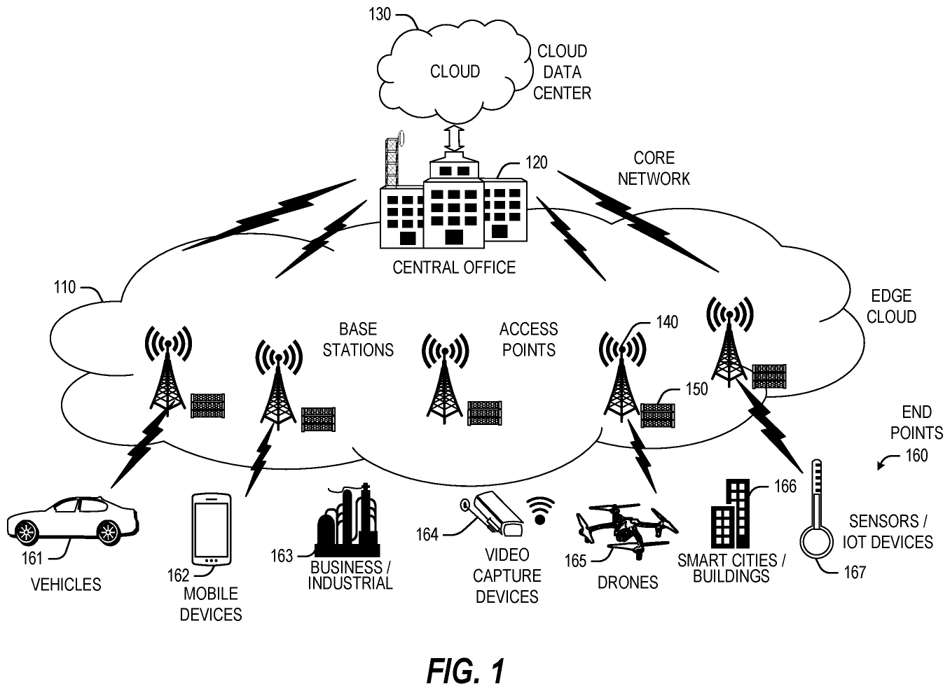

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

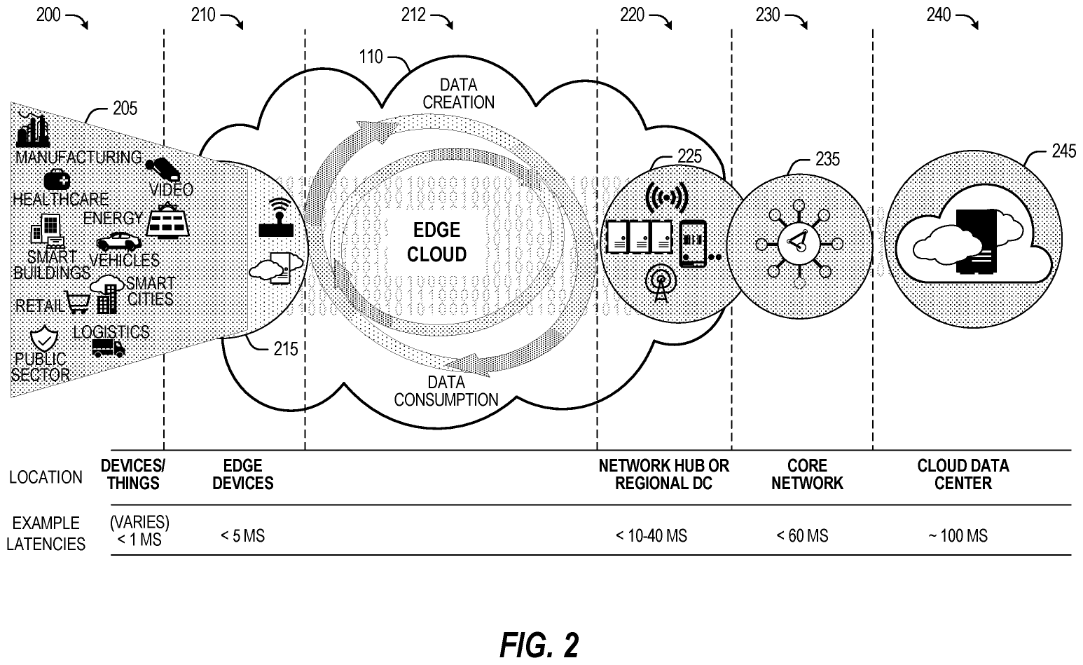

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to service level agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

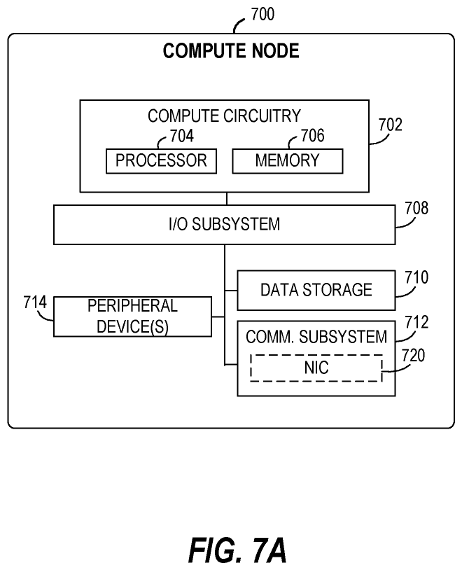

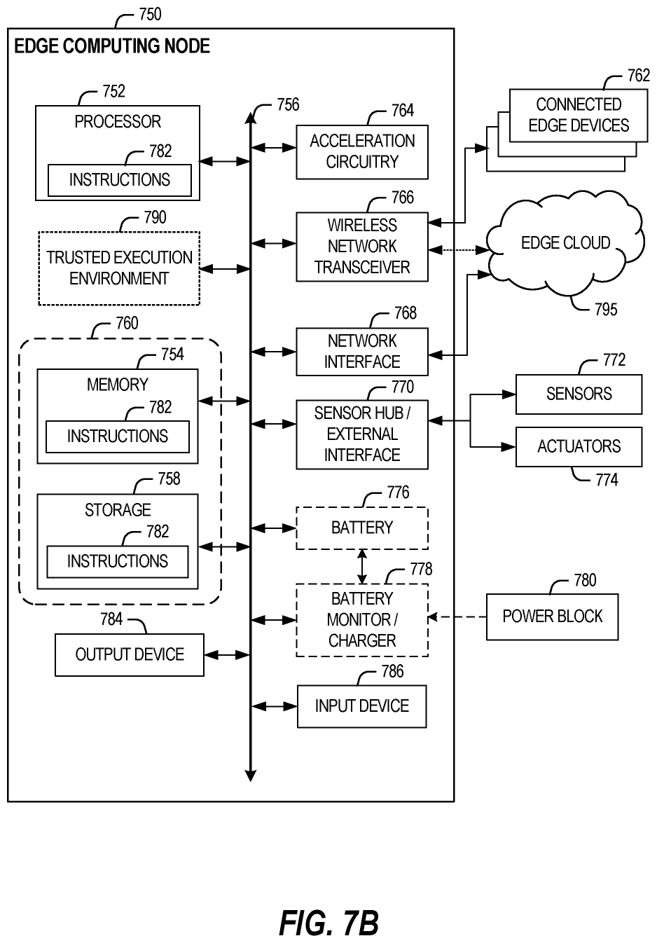

The network components of the edge cloud 110 may be servers, multi-tenant servers, appliance computing devices, and/or any other type of computing devices. For example, the edge cloud 110 may be an appliance computing device that is a self-contained processing system including a housing, case or shell. In some cases, edge devices are devices presented in the network for a specific purpose (e.g., a traffic light), but that have processing or other capacities that may be harnessed for other purposes. Such edge devices may be independent from other networked devices and provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 7B. The edge cloud 110 may also include one or more servers and/or one or more multi-tenant servers. Such a server may implement a virtual computing environment such as a hypervisor for deploying virtual machines, an operating system that implements containers, etc. Such virtual computing environments provide an execution environment in which one or more applications may execute while being isolated from one or more other applications.

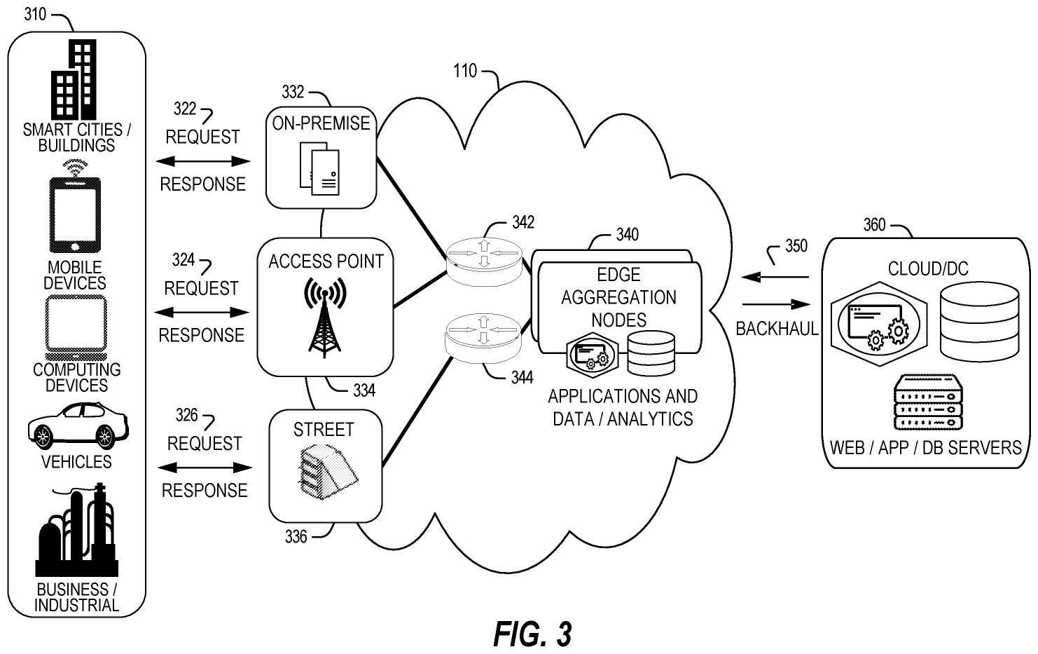

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

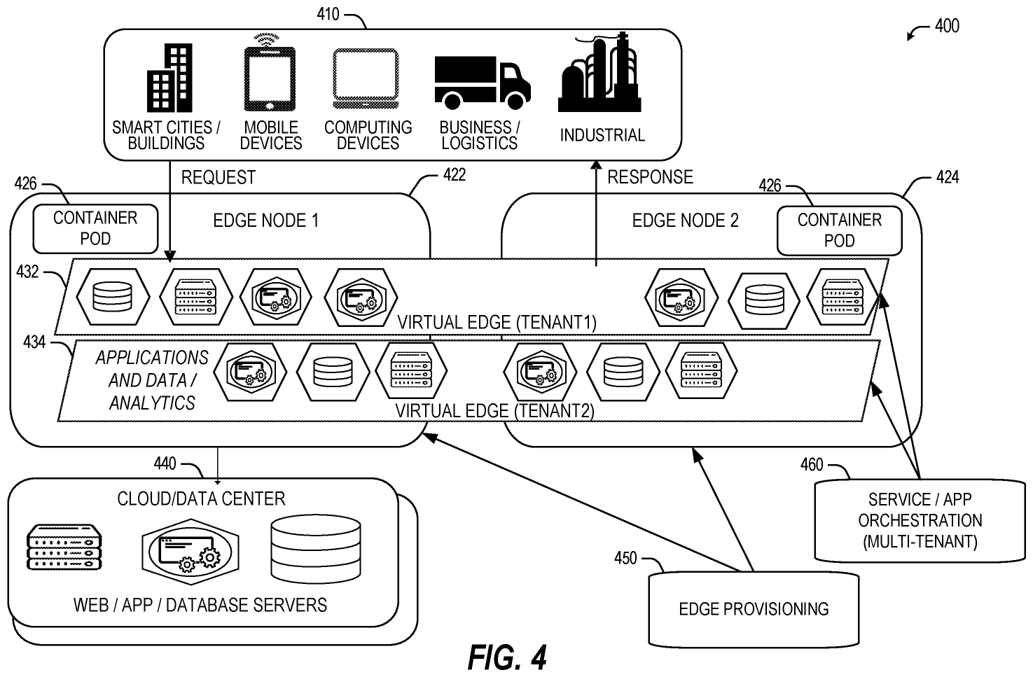

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices in 410 are multi-tenant devices where Tenant 1 may function within a tenant 1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

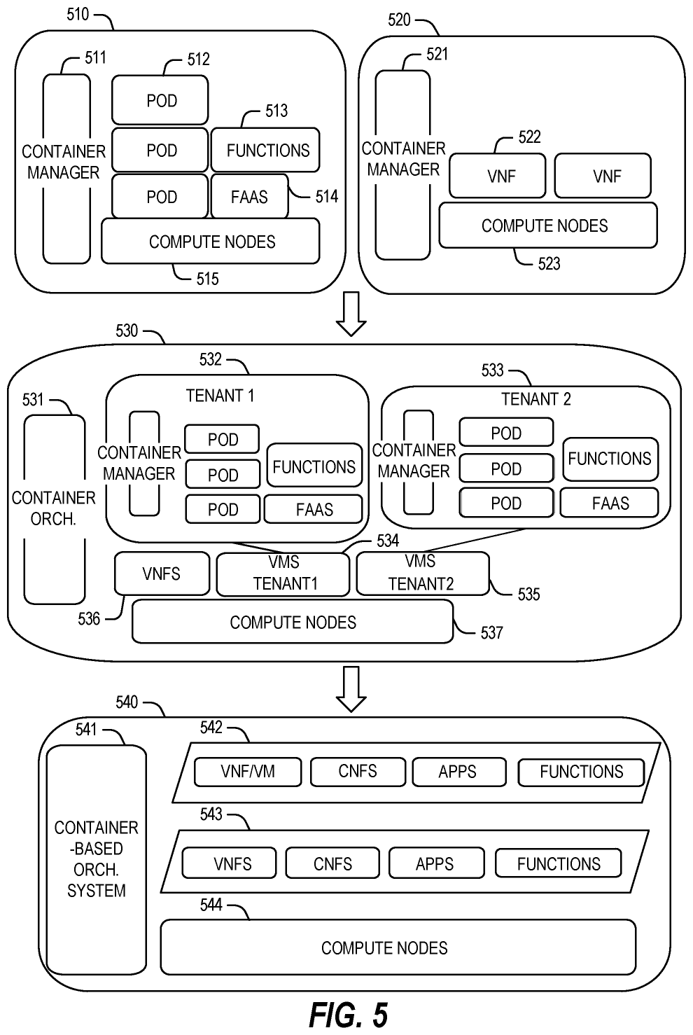

FIG. 5 illustrates additional compute arrangements deploying containers in an edge computing system. As a simplified example, system arrangements 510, 520 depict settings in which a pod controller (e.g., container managers 511, 521, and container orchestrator 531) is adapted to launch containerized pods, functions, and functions-as-a-service instances through execution via compute nodes (515 in arrangement 510), or to separately execute containerized virtualized network functions through execution via compute nodes (523 in arrangement 520). This arrangement is adapted for use of multiple tenants in system arrangement 530 (using compute nodes 537), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides containers 542, 543, or execution of the various functions, applications, and functions on compute nodes 544, as coordinated by an container-based orchestration system 541.

The system arrangements of depicted in FIG. 5 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

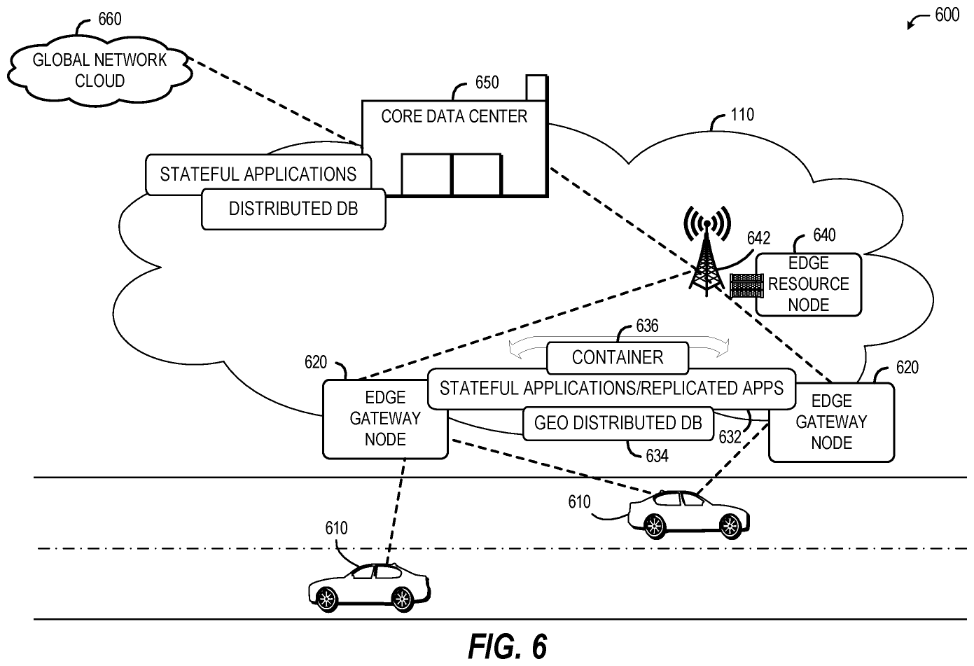

It should be appreciated that the edge computing systems and arrangements discussed herein may be applicable in various solutions, services, and/or use cases involving mobility. As an example, FIG. 6 shows a simplified vehicle compute and communication use case involving mobile access to applications in an edge computing system 600 that implements an edge cloud 110. In this use case, respective client compute nodes 610 may be embodied as in-vehicle compute systems (e.g., in-vehicle navigation and/or infotainment systems) located in corresponding vehicles which communicate with the edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular edge gateway device 620 may propagate so as to maintain a consistent connection and context for the client compute node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client compute nodes 610 may be performed on one or more of the edge gateway devices 620.

The edge gateway devices 620 may communicate with one or more edge resource nodes 640, which are illustratively embodied as compute servers, appliances or components located at or in a communication base station 642 (e.g., a based station of a cellular network). As discussed above, the respective edge resource nodes 640 include an amount of processing and storage capabilities and, as such, some processing and/or storage of data for the client compute nodes 610 may be performed on the edge resource node 640. For example, the processing of data that is less urgent or important may be performed by the edge resource node 640, while the processing of data that is of a higher urgency or importance may be performed by the edge gateway devices 620 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicate with the core data center 650, which may include compute servers, appliances, and/or other components located in a central location (e.g., a central office of a cellular communication network). The core data center 650 may provide a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource nodes 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource nodes 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 636 (or pod of containers) may be flexibly migrated from an edge node 620 to other edge nodes (e.g., 620, 640, etc.) such that the container with an application and workload does not need to be reconstituted, re-compiled, re-interpreted in order for migration to work. However, in such settings, there may be some remedial or “swizzling” translation operations applied. For example, the physical hardware at node 640 may differ from edge gateway node 620 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node 640, and others in the core data center 650 or global network cloud 660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 600 can include or be in communication with an edge provisioning node. The edge provisioning node may distribute software such as the example computer readable instructions 782 of FIG. 7B, to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer readable instructions 782 of FIG. 7B. The receiving parties may be consumers, service providers, users, retailers, OEMs, etc., who purchase and/or license the software instructions for use and/or re-sale and/or sub-licensing.

In an example, edge provisioning node 644 includes one or more servers and one or more storage devices. The storage devices host computer readable instructions such as the example computer readable instructions 782 of FIG. 7B, as described below. Similarly to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer readable instructions 782 from the edge provisioning node 644. For example, the software instructions, which may correspond to the example computer readable instructions 782 of FIG. 7B, may be downloaded to the example processor platform/s, which is to execute the computer readable instructions 782 to implement the methods described herein.

In some examples, the processor platform(s) that execute the computer readable instructions 782 can be physically located in different geographic locations, legal jurisdictions, etc. In some examples, one or more servers of the edge provisioning node 644 periodically offer, transmit, and/or force updates to the software instructions (e.g., the example computer readable instructions 782 of FIG. 7B) to ensure improvements, patches, updates, etc. are distributed and applied to the software instructions implemented at the end user devices. In some examples, different components of the computer readable instructions 782 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted in FIGS. 7A and 7B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 7A, an edge compute node 700 includes a compute engine (also referred to herein as “compute circuitry”) 702, an input/output (I/O) subsystem 708, data storage 710, a communication circuitry subsystem 712, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (e.g., an edge gateway of an implementing edge computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an edge gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective edge compute node (whether a client, gateway, or aggregation node) in an edge computing system or like forms of appliances, computers, subsystems, circuitry, or other components.

In a more detailed example, FIG. 7B illustrates a block diagram of an example of components that may be present in an edge computing node 750 for implementing the techniques (e.g., operations, processes, methods, and methodologies) described herein. This edge computing node 750 provides a closer view of the respective components of node 700 when implemented as or as part of a computing device (e.g., as a mobile device, a base station, server, gateway, etc.). The edge computing node 750 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 750, or as components otherwise incorporated within a chassis of a larger system.

The edge computing device 750 may include processing circuitry in the form of a processor 752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, Calif. As an example, the processor 752 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAPTM processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 758 may also couple to the processor 752 via the interconnect 756. In an example, the storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected edge devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at a different range. For example, the edge computing node 750 may communicate with close devices, e.g., within about 10 meters, using a local transceiver based on Bluetooth Low Energy (BLE), or another low power radio, to save power. More distant connected edge devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the edge cloud 795 via local or wide area network protocols. The wireless network transceiver 766 may be a low-power wide-area (LPWA) transceiver that follows the IEEE 802.15.4, or IEEE 802.15.4g standards, among others. The edge computing node 750 may communicate over a wide area using LoRaWANTM (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the edge cloud 795 or to other devices, such as the connected edge devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The edge computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the edge computing node 750 to actuators 774, such as power switches, valve actuators, an audible sound generator, a visual warning device, and the like.

In some optional examples, various input/output (I/O) devices may be present within or connected to, the edge computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 750. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 776 may power the edge computing node 750, although, in examples in which the edge computing node 750 is mounted in a fixed location, it may have a power supply coupled to an electrical grid, or the battery may be used as a backup or for temporary capabilities. The battery 776 may be a lithium ion battery, or a metal-air battery, such as a zinc-air battery, an aluminum-air battery, a lithium-air battery, and the like.

A battery monitor/charger 778 may be included in the edge computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, Tex. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the edge computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the edge computing node 750. A wireless battery charging circuit, such as an LTC4020 chip from Linear Technologies of Milpitas, California, among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application specific integrated circuit (ASIC).

In an example, the instructions 782 provided via the memory 754, the storage 758, or the processor 752 may be embodied as a non-transitory, machine-readable medium 760 including code to direct the processor 752 to perform electronic operations in the edge computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 750 through the TEE 790 and the processor 752.

In further examples, a machine-readable medium also includes any tangible medium that is capable of storing, encoding, or carrying instructions for execution by a machine and that cause the machine to perform any one or more of the methodologies of the present disclosure or that is capable of storing, encoding, or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

As discussed above, edge computing involves many scenarios where computing is performed at the edge, such as closer to users such as base stations/cell towers and central offices. An edge system may proactively react based on predictions (e.g., estimates) or changes to power availability, workload constraints, scheduling, etc. For example, power may be added when network bandwidth or some sensor bandwidth increases. In an example, workloads are executed when power is less expensive or when power is generated from renewable sources. A node may be scheduled to operate (e.g., execute a workload) at a frequency and power level that is the most efficient or more efficient than a schedule not taking the power level into account. For example, a CPU may be overclocked to run at a fast rate, but doing so may generate heat at a rate higher than if the frequency remained at a lower rate. The tradeoff of heat (e.g., excess power usage) to available power may be used to determine parameters of CPU clock frequency or timing of when a particular workload is executed (e.g., at night when ambient temperature is cooler). The more or most efficient power to heat window may be used as criteria for scheduling workloads.

Heat causes an issue in an edge device because more power is required to cool components. For example, as the CPU heats up, more fan power or other cooling action is needed to keep the CPU within operating temperatures. When operating during periods of high ambient heat, more power may be required to cool the components.

Individual control of power output to or used by a component may be used to manage power consumption. For example, new power states for one, a set, or all components of FIG. 7B, for example, may be used to reduce power consumption. For example, a power state for controlling power may be generated for any of the processor 752, the machine-readable medium 760 (e.g., the memory 754), the output device 784, the acceleration circuitry 764, the wireless network transceiver 766, the network interface 768, the input device 786, the sensor hub/external interface 770, or components attached to the edge computing node 750 (e.g., connected edge devices 762, sensors 772, or actuators 774).

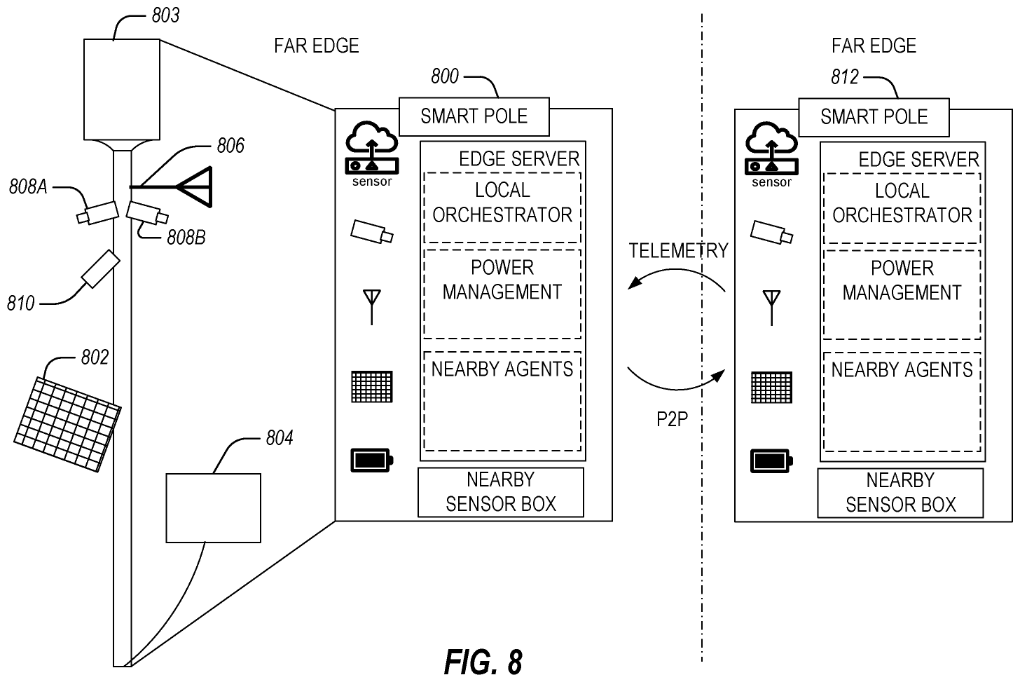

FIG. 8 illustrates a renewable energy powered edge appliance device 800 in accordance with some embodiments. The renewable energy powered edge appliance device 800 includes a renewable power source (e.g., a solar power collector 802 or a wind power collector 803), a battery 804, and an antenna 806 (e.g., a backhaul connection component). The renewable energy powered edge appliance device 800 may include one or more optional components such as a camera (e.g., 808A, 808B) or a vehicle connection 810 (e.g., V2X transceiver). In an example, the renewable energy powered edge appliance device 800 may have no connection to a power grid or no physical connection to a network, in other examples, the edge appliance device 800 may use grid energy as a backup or alternative to the green power. The renewable energy powered edge appliance device 800 may be secured with a lock and include ventilation.

The various components of the renewable energy powered edge appliance device 800 do not all need to be present at an edge device. Other configurations are possible, the components and arrangements of the renewable energy powered edge appliance device 800 shown in FIG. 8 are one example set of components and arrangements. For example, a different power supply may be used (e.g., wind power), more or fewer cameras, batteries, or communication components may be used, etc.

In an example, the renewable energy powered edge appliance device 800 is a node in an edge network. Edge computing involves usage of compute nodes in constrained environments. In an example, nodes are green edge deployments based on solar power. In some examples, these green edge deployments may be based on standard platforms, as opposed to specialized configurations (e.g., a low-power configuration), for ease-of-use, adaptability, SW usage, or configurability to include accelerators, etc. Power is a constraint that becomes a factor in such scenarios, such as while prioritizing and scheduling different tasks.

There are several factors that are considered by the renewable energy powered edge appliance device 800 while evaluating the impact on power consumption for scheduling or prioritizing tasks. For example, the renewable energy powered edge appliance device 800 may consider compute resources being used, including cores, programmable logic, accelerators, and the frequencies or speeds of operation of these resources, memory resources being used, including DRAM, DCPMM (Optane memory), and their associated capacity or bandwidth configurations, storage or network resources being used, or the like. In an example, the power considerations may be applied to software components. There are many types of software components that may be executed on the renewable energy powered edge appliance device 800, including for example, edge services being offered to edge users (for example, a service offered to autonomous cars or a service to drones), system software components, which may span various parts of the software stack, such as OS, driver, or application SW that do not form part of services, etc. In some examples, learning components may move or migrate to other systems.

The renewable energy powered edge appliance device 800 is illustrated in FIG. 8 with components (e.g., optional components), such as sensors, cameras, antennas, solar power, wind power, batteries, a local orchestrator, power management component, nearby agent communication or information storage, nearby sensor box communication or information storage, or the like. The renewable energy powered edge appliance device 800 may communicate with another edge device 812, such as an edge device near in distance or communication distance to the renewable energy powered edge appliance device 800 or a device designated by an orchestrator or via previous discovery. In an example, the other edge device 812 is powered by renewable energy. In some examples, the other edge device 812 may be an edge device that optionally operates with power from a power grid (e.g., non-renewable). In some examples, the other edge device 812 may be connected by a wired connection to a network. The renewable energy powered edge appliance device 800 and the other edge device 812 may exchange orchestration, telemetry, or other data for coordinating actions of the renewable energy powered edge appliance device 800 and other edge devices, for example using a P2P communication between the renewable energy powered edge appliance device 800 and the other edge device 812.

The present systems and techniques provide for dynamic edge scheduling among edge devices in an edge system (e.g., a group of edge devices, such as ones sharing a common geography). The edge system may include the renewable energy powered edge appliance device 800. In an example, edge devices such as the renewable energy powered edge appliance device 800 may operate independently of a central office to optimize power loads and resources.

A roadside unit (RSU) is a compute device that is situated at locations closer to data sources for edge computing. The location of the RSU is ideally as close to the data source as possible (e.g., when the data source/target is a set of cars travelling on a highway, coverage along the entire highway is ideal). In an example, an RSU may include an Edge Solar Based V2X cabinet, with a battery, a number of cameras (e.g., two, four, eight, ten, etc.), or a wireless connector. Some of a set of deployed RSUs, depending on location, may be plugged into the grid, and others may be in remote locations with an unavailability of grid hook ups based on terrain, remoteness, etc.

The RSUs may be situated to enable remote sensing or obtain data at the RSUs with very low latency or to perform compute. In some examples, RSUs have peer to peer connectivity. Different RSUs may have different energy reserves or power sources, and accordingly, they may have different power available for computational tasks or communication. The differences in power availability may be based on access to the grid, available ambient power (e.g., solar or wind power), battery availability, or the like. Differences may be based on ambient power sources like solar or wind exhibiting burstiness in power harvesting, due to wind availability, time of day, cloudiness, etc. Differences may be based on usage, such as depending on the compute or communication tasks assigned among RSUs.

Actions may be taken among the RSUs to conserve power differently based on the differences in available energy per RSU. For example, an RSU with excess energy may be able to clock to much higher frequencies when compared to an RSU that is low on available energy. In an example, other variables may include a number of active cores, memory ranks turned off, wireless transmission capability, or the like at a given RSU.

In some examples, system-wide (e.g., for a system of RSUs, such as in a geographic area), criteria may be used, such as to ensure that at least N RSUs have at least X Joules of reserve energy for survivability. Task scheduling decisions may be made such that they are reconciled against ambient availability, predictions of incoming energy, current load across RSUs, and prediction of usage. The system-wide criteria may include minimizing energy usage or optimizing energy usage of the system. In such edge environments, energy or power may be considered a first class resource (e.g., a currency) for decision making and sharing among RSUs.

The systems and techniques described herein provide a framework in edge deployments, such as with RSUs, where an edge device may schedule a particular function using a cooperative flow between the various edge devices to determine an optimal edge device of a system for performing the compute. System-wide criteria may be used to calculate an energy score (e.g., for performing a particular function at a particular edge device). Energy scores of performing a function at each of a set of edge devices may be compared to identify a ranking of edge devices according to their energy scores. A highest ranked energy score may correspond to an edge device used for performing the function. The energy score may be based on criteria such as power availability, power source (e.g., renewable, grid, battery, etc.), power reliability (e.g., likelihood of power loss in future, such as due to battery or renewable constraints), bandwidth, number of hops, energy consumed, etc.

The energy score may include available Watts at an edge device, a percentage of battery charge available, voltage available for use, voltage needed for completing a function, etc. The energy score may include likely minutes or hours of downtime, predicted failure rate, available photovoltaics (e.g., for solar power), wind speed or direction (e.g., for wind power), or the like.

In an example, for a given request f( )to be processed to a payload X within a certain SLA (e.g., latency, cost etc.), the edge device selection may consider power available in each edge device, or corresponding virtual cost in terms of power units available, latencies between or among the corresponding edge device and the rest of the edge devices, power costs for moving X (e.g., network associated power consumption given the network capabilities), power availability or compute availability in each edge device to perform f( ) or the like. The edge device or the system of edge devices may track overall available energy as per edge minimum reserve energy criteria for survival, in some examples. P2P communications between edge devices in the system may be used to discover the current capabilities of peers. This may include other factors such as potential better future power availability that an edge device may harvest. In some examples, a network protocol may be selected based on consumption (e.g., protocol A consumes 50% less than B but at 2×slow speed).

Different edge devices have different power charges. The usage of that power to achieve a certain computation may have a different cost or different implications to the overall hive of edge devices. Thus, edges with less power may have a higher cost (or virtually more scarce power units) to achieve that computation. The edge device with higher power available may have a lower cost (or virtually richer in power) to achieve the same compute.

Different latencies and bandwidths between each of the edge devices may be observed (e.g., via wireless P2P communication). This communication bandwidth may depend on the use of the various links. Different communication technologies or routes between an edge and peers may be used.

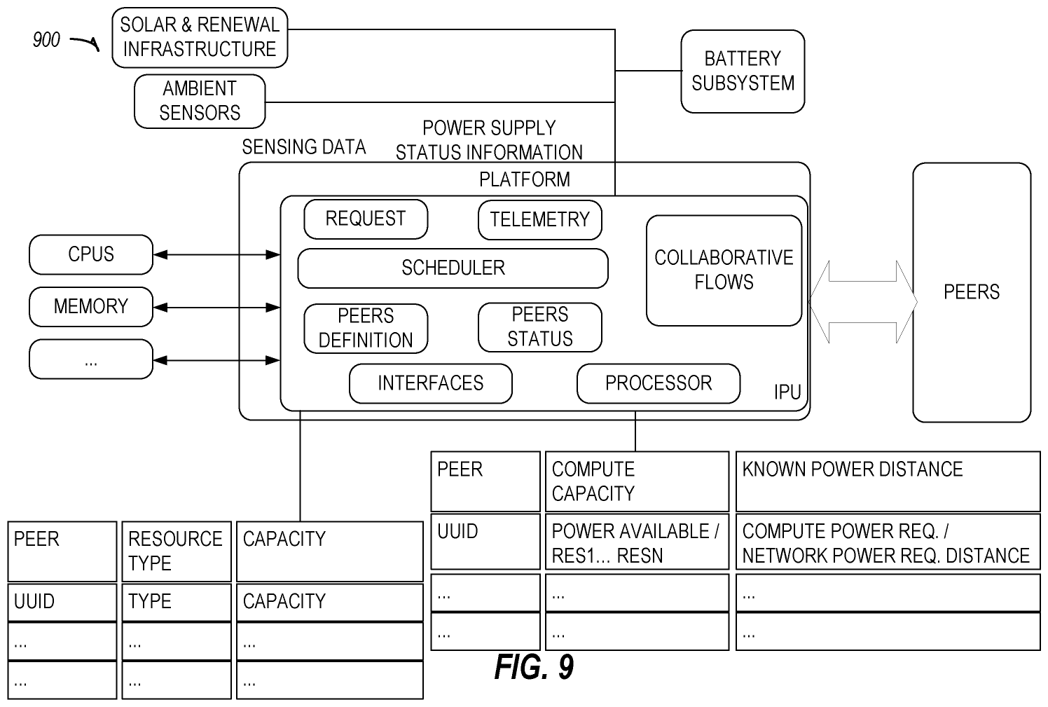

FIG. 9 illustrates an example system block diagram 900 in accordance with some embodiments. The diagram 900 provides an example description of an edge node (e.g., RSU, Base station, etc.). In an example, the diagram 900 may include components of an IPU of an edge device. In another example, components of the diagram 900 may be present in other places within a platform (e.g., the platform itself, CPU accelerator, discrete accelerator etc.).

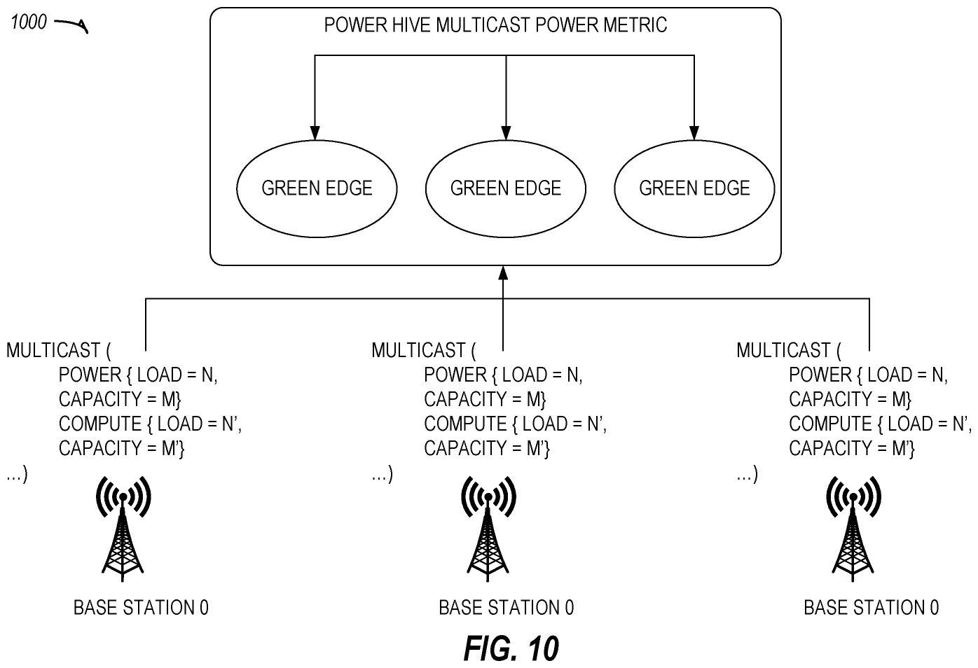

The diagram 900 includes a set of new interfaces for dynamic scheduling at a system of edge devices. In an example, an interface allows static information to be registered related to various peers in that are accessible from a network perspective. As shown in FIG. 10 below, each edge joining into a hive of virtual power may multicast to the rest of the peers of the hive (e.g., using a hive ID as multicast). Information provided may include a UUID of the edge node, a list of resources (e.g., including a resource type, such as accelerator type, CPU type, etc., a capacity of respective accelerators, etc.), or the like.

An example interface may be used to periodically update nodes in the hive to register their current status. Similar to the previous interface, this may be implemented via a multicast flow using the hive ID. Each edge may provide information including a UUID of the edge node, or a list of resources current availability, including for example resource type, current resource availability, current power consumption of a particular resource given the current circumstances (ambient temperature, usage, etc.), amount of power available, or the like.

An example interface may be used by the infrastructure (e.g., different IPUs doing active probes between themselves to understand latency and bandwidth available in one particular direction) to register a list of UUID of the node with whom the latency and bandwidth are provided, a list of potential routes (that may include different technologies) between the current edge and the node, or the like. In this interface, per route information may be provided, such as current latency between the specific node and the other node, current bandwidth between the specific node and the other node, amount of power or bytes that are going to be consumed given current bandwidth, network utilization, characteristics of the network or other characteristics, or the like.

FIG. 10 illustrates an example multicast diagram 1000 in accordance with some embodiments. As mentioned above, diagram 1000 illustrates multicasting among edge devices in a hive or system. Each edge device may provide telemetry or other information to the other edge devices. Telemetry logic may collect any needed information that is required in order to perform the described flows. The telemetry gathered may include resources, including information pertaining to available resources, current power consumption normalized to ambient metrics, (e.g., to processes one teraflop the CPU will consume 100 Watts/flop because current temperature is 50 in normal conditions of 30 it would 40 Watts/flop), ambient information such as temperature external or internal the cabinet or similar type of information that may be shared and maybe used for the scheduling logic, green energy metrics such as information that refers to an amount of energy that is currently available for compute (e.g., energy that is stored in the battery, energy that is currently harvested from the sun or wind, estimation of the energy that will be available in the next 12 hours, or the like), power budget that may be consumed during a next time period (e.g., 12 hours) in order to be sure that node does not run out of energy, or the like.

Request logic may be used to implement the flow described earlier when a particular function is to be executed. This function may be requested by a software stack running in the platform. When a process request f( ) to a payload X within certain SLA (latency, cost etc.) occurs, the edge selection may factor power available in each edge and the corresponding virtual cost in terms of power units available (different cost will incur if the edges have specialized hardware that fits to the specific request), latencies between the corresponding edge and the rest of edges, power costs that will determine on moving X (network associated power consumption and given the network capabilities), power available and compute availability in each edges to perform f( ) or the like.

The request logic may use last known information of the status of the peers and network to filter the peers that may be able to satisfy (e.g., given the compute and data movement requirements) the SLA. The request logic may order peers according to an amount of energy that they have while avoiding giving a higher grade to ones that have high compute demand. This may include placing nodes at the top that have high battery levels or where irradiated energy may be used. The request logic may iteratively check the selected nodes, for example in order (potentially generating multiple queries on parallel). Checking may include notifying a peer the need to execute a particular function that will use a list of resources with a given quantity, and notifying the peer that it will need to copy over a certain amount of data and retrieve certain amount of that using a specific route. Once a peer has been selected and agrees to take the function, the request logic may send the data using the selected route along with the request to execute the function (provided by the data), and retrieve the result of the function after performance using a selected retrieving route. Collaborative flow logic may be used to implement the flows that have been already described above.

In some examples, fabric protocols (e.g., IPU based) may take care of compute delegation from a host perspective to make the system more scalable and automatically distributed. An application may spawn a microservice into the IPU with certain network and compute/resource requirements. The IPU may work in a P2P mode in order to decide the best place to run that service. The IPU may consider optimizing power consumption (e.g., factoring power network consumption and compute power) when delegating. For example, the IPU may decide against moving a function two hops from a first edge (e.g., one that has very minimum power) to a second edge (e.g., a potential target with enough compute) because the network and compute is higher than a third edge that has enough accelerated compute at less power, though the third edge is four hops away.

The IPU may become a control point, in addition to being used for purposes of secure boot, root of trust, HW and SW authentication and authorization, resource management, health, QoS and traffic management enforcement. Based on power analytics (e.g., including predictive analytics), IPUs may autonomously talk to each other and select a most optimal (from a total system power optimization point of view) workload locations for the entire service chain across the edge and multi-cloud. When some centralized control system deploys the workload on a particular node, the IPU in such a node may delegate the processing to another trusted node capable of performing the task, in some examples.

Information centric networking (ICN) is a transport layer or internet layer protocol that is an alternative to address-based approaches, such as the Internet Protocol (IP). ICN replaces host addresses with named data (or functions in a named function networking (NFN)). ICN nodes generally include two data structures, a pending interest table (PIT) and a forwarding information base (FIB) that are used for routing.

When data is desired, a requestor releases an interest packet naming the data being sought. A receiving ICN node records the interest packet arrival along with the physical interface upon which the interest was received in a PIT entry. The ICN node uses the FIB to determine upon which physical interface to forward the interest. When a node has data that matches the name of the interest packet, such a node generally responds to the interest packet in a data packet (e.g., ICN data packet). When the data packet arrives at an interim node, that node matches the name of the data packet with a PIT entry and uses the physical interface of the PIT entry to forward the data; the PIT entry being removed once the data packet is sent.

Because only the name of the data is necessary, data may be cached throughout the network without orchestration present in host-based techniques. Thus, as a data packet traverses an interim ICN node, that node may cache the data packet to respond to future requests for the same data.

Example ICN networks include content centric networking (CCN), as specified in the Internet Engineering Task Force (IETF) draft specifications for CCNx 0.x and CCN 1.x, and named data networking (NDN), as specified in the NDN technical report DND-0001.

In an example, a named data networking (NDN) protocol may be used to negotiate the processing and proxying capabilities, so that the IPUs may use NDN for inter-IPU protocol to perform such workload assignment. In an example, NDN may include power-related extensions. In another example, power functionality may remain with the IPU functions. Such IPU functions may to talk to an NDN layer to finalize an assignment task.

In an example, a battery of a base station may be full, and energy that could be harvested may be lost. By moving functions onto the base station from a base station having a battery that is not full (or not anticipated to fill up over a given time period), ambient energy may be harvested that would otherwise be lost to the system. This improves overall energy availability in the system. In another example, less energy may be harvested over a time period (e.g., due to lack of sunlight or insufficient wind), for example on a rainy or cloudy day. In this example, more aggressive energy saving techniques may be used, such as moving functions to a base station attached to a network or grid. The systems and techniques described herein provide optimization for periods where there is more irradiation in one tower and less in others or more energy that may be harvested than is being used in one tower versus another.

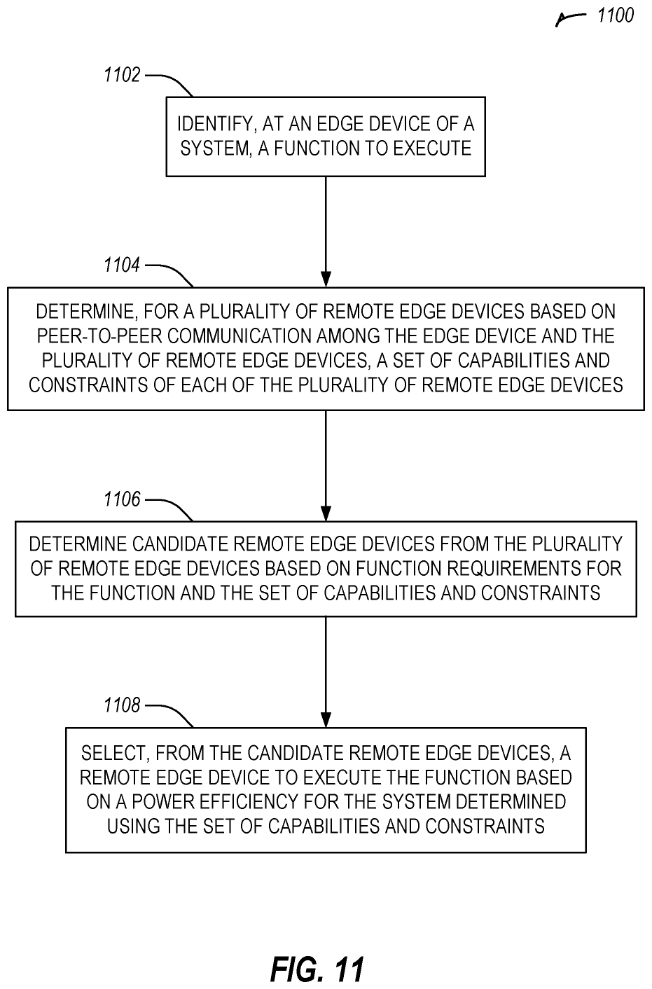

FIG. 11 illustrates a flowchart showing a technique 1100 for dynamic edge scheduling in accordance with some embodiments. The technique 1100 may be performed by an edge device, such as using memory to store instructions for execution by processing circuitry. The edge device may be part of a system or hive (e.g., a group of edge devices in a particular area, within a particular distance or communication distance of each other, a designated group of devices, such as by an orchestrator, or the like).

The technique 1100 includes an operation 1102 to identify, at an edge device of a system, a function to execute. The technique 1100 includes an operation 1104 to determine, for a plurality of remote edge devices based on peer-to-peer communication among the edge device and the plurality of remote edge devices, a set of capabilities and constraints of each of the plurality of remote edge devices. The capabilities may include resources offered at each of the plurality of remote edge devices. The constraints may include power availability or power source at each of the plurality of remote edge devices. The technique 1100 includes an operation 1106 to determine candidate remote edge devices from the plurality of remote edge devices based on function requirements for the function and the set of capabilities and constraints.

The technique 1100 includes an operation 1108 to select, from the candidate remote edge devices, a remote edge device to execute the function based on an energy score for the system determined using the set of capabilities and constraints. In an example, the energy score for the system may be based on a minimization of battery usage of the candidate remote edge devices and the edge device in the system. The an energy score for the system may be indicated by usable renewable power of the remote edge device, for example when renewable power of the edge device is unavailable.

Operation 1108 may include identifying a number of hops to the remote edge device from the edge device, the number of hops fulfilling a number of hops requirement corresponding to the function. Operation 1108 may include determining a latency at the remote edge device, the latency fulfilling a latency requirement corresponding to the function. Operation 1108 may include receiving a power availability at the remote edge device. Operation 1108 may include receiving a resource availability at the remote edge device capable of executing the function. Operation 1108 may include selecting the remote edge device based on the remote edge device having a maximum available battery power among the candidate remote edge devices. Operation 1108 may include selecting the remote edge device based on the remote edge device being capable of fulfilling an SLA or SLO for the function. Selecting the remote edge device may include selecting a particular route of edge devices for sending data corresponding to the function to the remote edge device.

Operation 1108 may include using at least one of power available in each select of the candidate remote edge devices and a corresponding cost to the power available when executing the function, a latency between the edge device and each of the candidate remote edge devices, a power cost of moving the function to each of the candidate remote edge devices, or the like. The technique 1100 may include notifying the remote edge device to execute the function, for example by sending an identification of a list of resources of the remote edge device to use for execution of the function.

After selecting a candidate remote edge device to execute the function, the technique 1100 may include instantiating the selected remote edge device. In an example, instantiating the selected remote edge device includes powering the selected remote edge device on part way, rather than fully powering up the selected remote edge device. In some examples, the selected remote edge device may be off or in a powered down state when selected, for example based on past data (e.g., when the edge device knows that the selected remote edge device is capable of executing the function from past interactions or data). In this example, notifying the selected remote edge device may include identifying what components to activate and to what level of power at the selected remote edge device.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together (e.g., including over a wire, over a network, using one or more platforms, wirelessly, via a software component, or the like), comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Each of these non-limiting examples may stand on its own, or may be combined in various permutations or combinations with one or more of the other examples.

Example 1 is an edge device of a system of edge devices for dynamic edge scheduling, the edge device comprising: memory including instructions; and processing circuitry that, when in operation, is configured by the instructions to perform operations to: identify, at the edge device, a function to execute; determine, for a plurality of remote edge devices of the system based on peer-to-peer communication among the edge device and the plurality of remote edge devices, a set of capabilities and constraints of the plurality of remote edge devices; determine candidate remote edge devices from the plurality of remote edge devices based on function requirements for the function and the set of capabilities and constraints; rank the candidate remote edge devices according to an energy score for the system determined using the set of capabilities and constraints; and select, from the ranked candidate remote edge devices, a top ranked remote edge device to execute the function.

In Example 2, the subject matter of Example 1 includes, wherein capabilities of the set of capabilities and constraints include resources offered at each of the plurality of remote edge devices.

In Example 3, the subject matter of Examples 1-2 includes, wherein constraints of the set of capabilities and constraints include at least one of power availability, power source, or power reliability, at each of the plurality of remote edge devices.

In Example 4, the subject matter of Examples 1-3 includes, wherein the remote edge device is selected based on a number of hops to the remote edge device from the edge device, the number of hops fulfilling a number of hops requirement corresponding to the function.

In Example 5, the subject matter of Examples 1-4 includes, wherein the remote edge device is selected based on a latency at the remote edge device, the latency fulfilling a latency requirement corresponding to the function.

In Example 6, the subject matter of Examples 1-5 includes, wherein the remote edge device is selected based on a power availability at the remote edge device.

In Example 7, the subject matter of Examples 1-6 includes, wherein the remote edge device is selected based on a resource availability at the remote edge device capable of executing the function.

In Example 8, the subject matter of Examples 1-7 includes, wherein to select the remote edge device includes using at least one of power available in each select of the candidate remote edge devices and a corresponding cost to the power available when executing the function, a latency between the edge device and each of the candidate remote edge devices, or a power cost of moving the function to each of the candidate remote edge devices.

In Example 9, the subject matter of Examples 1-8 includes, wherein the energy score corresponds to a minimization of battery usage of the candidate remote edge devices and the edge device in the system.

In Example 10, the subject matter of Examples 1-9 includes, wherein the energy score corresponds to renewable power of the remote edge device.

In Example 11, the subject matter of Examples 1-10 includes, wherein the remote edge device is selected based on the remote edge device having a maximum available battery power among the candidate remote edge devices.

In Example 12, the subject matter of Examples 1-11 includes, wherein the remote edge device is selected based on the remote edge device being capable of fulfilling an SLA for the function.

In Example 13, the subject matter of Examples 1-12 includes, wherein the operations further include to notify the remote edge device to execute the function, including an identification of a list of resources of the remote edge device to use for execution of the function.

In Example 14, the subject matter of Examples 1-13 includes, wherein to select the remote edge device includes selecting a particular route of edge devices for sending data corresponding to the function to the remote edge device.

Example 15 is a method for using processing circuitry of an edge device of a system of edge devices, the method comprising: identifying, at the edge device, a function to execute; determining, for a plurality of remote edge devices of the system based on peer-to-peer communication among the edge device and the plurality of remote edge devices, a set of capabilities and constraints of each of the plurality of remote edge devices; determining candidate remote edge devices from the plurality of remote edge devices based on function requirements for the function and the set of capabilities and constraints; ranking the candidate remote edge devices according to an energy score for the system determined using the set of capabilities and constraints; and selecting, from the ranked candidate remote edge devices, a top ranked remote edge device to execute the function.

In Example 16, the subject matter of Example 15 includes, wherein capabilities of the set of capabilities and constraints include resources offered at each of the plurality of remote edge devices.

In Example 17, the subject matter of Examples 15-16 includes, wherein constraints of the set of capabilities and constraints include at least one of power availability, power source, or power reliability, at each of the plurality of remote edge devices.

In Example 18, the subject matter of Examples 15-17 includes, wherein selecting the remote edge device includes identifying a number of hops to the remote edge device from the edge device, the number of hops fulfilling a number of hops requirement corresponding to the function.

In Example 19, the subject matter of Examples 15-18 includes, wherein selecting the remote edge device includes determining a latency at the remote edge device, the latency fulfilling a latency requirement corresponding to the function.

In Example 20, the subject matter of Examples 15-19 includes, wherein selecting the remote edge device includes receiving a power availability at the remote edge device.

In Example 21, the subject matter of Examples 15-20 includes, wherein selecting the remote edge device includes receiving a resource availability at the remote edge device capable of executing the function.

In Example 22, the subject matter of Examples 15-21 includes, wherein selecting the remote edge device includes using at least one of power available in each select of the candidate remote edge devices and a corresponding cost to the power available when executing the function, a latency between the edge device and each of the candidate remote edge devices, or a power cost of moving the function to each of the candidate remote edge devices.

Example 23 is an apparatus comprising: means for identifying a function to execute; means for determining, for a plurality of remote edge devices based on peer-to-peer communication among the apparatus and the plurality of remote edge devices, a set of capabilities and constraints of each of the plurality of remote edge devices; means for determining candidate remote edge devices from the plurality of remote edge devices based on function requirements for the function and the set of capabilities and constraints; means for ranking the candidate remote edge devices according to an energy score for the system determined using the set of capabilities and constraints; and means for selecting, from the ranked candidate remote edge devices, a top ranked remote edge device to execute the function.

In Example 24, the subject matter of Example 23 includes, wherein the means for selecting the remote edge device include means for selecting a particular route of edge devices for sending data corresponding to the function to the remote edge device.

Example 25 is at least one non-transitory machine-readable medium including instructions, which when deployed and executed by a processing circuitry of an edge device of a system of edge devices, cause the processing circuitry to: identify a function to execute; determine, for a plurality of remote edge devices of the system based on peer-to-peer communication among the edge device and the plurality of remote edge devices, a set of capabilities and constraints of each of the plurality of remote edge devices; determine candidate remote edge devices from the plurality of remote edge devices based on function requirements for the function and the set of capabilities and constraints; rank the candidate remote edge devices according to an energy score for the system determined using the set of capabilities and constraints; and select, from the ranked candidate remote edge devices, a top ranked remote edge device to execute the function.

Example 26 is at least one machine-readable medium including instructions that, when executed by processing circuitry, cause the processing circuitry to perform operations to implement of any of Examples 1-25.

Example 27 is an apparatus comprising means to implement of any of Examples 1-25.

Example 28 is a system to implement of any of Examples 1-25.

Example 29 is a method to implement of any of Examples 1-25.

Another example implementation is an edge computing system, including respective edge processing devices and nodes to invoke or perform the operations of Examples 1-25, or other subject matter described herein.

Another example implementation is a client endpoint node, operable to invoke or perform the operations of Examples 1-25, or other subject matter described herein.

Another example implementation is an aggregation node, network hub node, gateway node, or core data processing node, within or coupled to an edge computing system, operable to invoke or perform the operations of Examples 1-25, or other subject matter described herein.

Another example implementation is an access point, base station, road-side unit, street-side unit, or on-premises unit, within or coupled to an edge computing system, operable to invoke or perform the operations of Examples 1-25, or other subject matter described herein.

Another example implementation is an edge provisioning node, service orchestration node, application orchestration node, or multi-tenant management node, within or coupled to an edge computing system, operable to invoke or perform the operations of Examples 1-25, or other subject matter described herein.

Another example implementation is an edge node operating an edge provisioning service, application or service orchestration service, virtual machine deployment, container deployment, function deployment, and compute management, within or coupled to an edge computing system, operable to invoke or perform the operations of Examples 1-25, or other subject matter described herein.

Another example implementation is an edge computing system including aspects of network functions, acceleration functions, acceleration hardware, storage hardware, or computation hardware resources, operable to invoke or perform the use cases discussed herein, with use of Examples 1-25, or other subject matter described herein.

Another example implementation is an edge computing system adapted for supporting client mobility, vehicle-to-vehicle (V2V), vehicle-to-everything (V2X), or vehicle-to-infrastructure (V2I) scenarios, and optionally operating according to ETSI MEC specifications, operable to invoke or perform the use cases discussed herein, with use of Examples 1-25, or other subject matter described herein.

Another example implementation is an edge computing system adapted for mobile wireless communications, including configurations according to an 3GPP 4G/LTE or 5G network capabilities, operable to invoke or perform the use cases discussed herein, with use of Examples 1-25, or other subject matter described herein.

Another example implementation is an edge computing node, operable in a layer of an edge computing network or edge computing system as an aggregation node, network hub node, gateway node, or core data processing node, operable in a close edge, local edge, enterprise edge, on-premise edge, near edge, middle, edge, or far edge network layer, or operable in a set of nodes having common latency, timing, or distance characteristics, operable to invoke or perform the use cases discussed herein, with use of Examples 1-25, or other subject matter described herein.

Another example implementation is networking hardware, acceleration hardware, storage hardware, or computation hardware, with capabilities implemented thereupon, operable in an edge computing system to invoke or perform the use cases discussed herein, with use of Examples 1-25, or other subject matter described herein.

Another example implementation is an edge computing system configured to perform use cases provided from one or more of: compute offload, data caching, video processing, network function virtualization, radio access network management, augmented reality, virtual reality, industrial automation, retail services, manufacturing operations, smart buildings, energy management, autonomous driving, vehicle assistance, vehicle communications, internet of things operations, object detection, speech recognition, healthcare applications, gaming applications, or accelerated content processing, with use of Examples 1-25, or other subject matter described herein.

Another example implementation is an apparatus of an edge computing system comprising: one or more processors and one or more computer-readable media comprising instructions that, when executed by the one or more processors, cause the one or more processors to invoke or perform the use cases discussed herein, with use of Examples 1-25, or other subject matter described herein.

Another example implementation is one or more computer-readable storage media comprising instructions to cause an electronic device of an edge computing system, upon execution of the instructions by one or more processors of the electronic device, to invoke or perform the use cases discussed herein, with use of Examples 1-25, or other subject matter described herein.

Another example implementation is an apparatus of an edge computing system comprising means, logic, modules, or circuitry to invoke or perform the use cases discussed herein, with use of Examples 1-25, or other subject matter described herein.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. An edge device of a system of edge devices for dynamic edge scheduling, the edge device comprising:
memory including instructions; and
processing circuitry that, when in operation, is configured by the instructions to perform operations to:
identify, at the edge device, a function to execute;
determine, for a plurality of remote edge devices of the system based on peer-to-peer communication among the edge device and the plurality of remote edge devices, a set of capabilities and constraints of the plurality of remote edge devices;
determine candidate remote edge devices from the plurality of remote edge devices based on function requirements for the function and the set of capabilities and constraints;
rank the candidate remote edge devices according to an energy score for the system determined using the set of capabilities and constraints; and
select, from the ranked candidate remote edge devices, a top ranked remote edge device to execute the function.

2. The edge device of claim 1, wherein capabilities of the set of capabilities and constraints include resources offered at each of the plurality of remote edge devices.

3. The edge device of claim 1, wherein constraints of the set of capabilities and constraints include at least one of power availability, power source, or power reliability, at each of the plurality of remote edge devices.

4. The edge device of claim 1, wherein the remote edge device is selected based on a number of hops to the remote edge device from the edge device, the number of hops fulfilling a number of hops requirement corresponding to the function.

5. The edge device of claim 1, wherein the remote edge device is selected based on a latency at the remote edge device, the latency fulfilling a latency requirement corresponding to the function.

6. The edge device of claim 1, wherein the remote edge device is selected based on a power availability at the remote edge device.

7. The edge device of claim 1, wherein the remote edge device is selected based on a resource availability at the remote edge device capable of executing the function.

8. The edge device of claim 1, wherein to select the remote edge device includes using at least one of power available in each select of the candidate remote edge devices and a corresponding cost to the power available when executing the function, a latency between the edge device and each of the candidate remote edge devices, or a power cost of moving the function to each of the candidate remote edge devices.

9. The edge device of claim 1, wherein the energy score corresponds to a minimization of battery usage of the candidate remote edge devices and the edge device in the system.

10. The edge device of claim 1, wherein the energy score corresponds to renewable power of the remote edge device.

11. The edge device of claim 1, wherein the remote edge device is selected based on the remote edge device having a maximum available battery power among the candidate remote edge devices.

12. The edge device of claim 1, wherein the remote edge device is selected based on the remote edge device being capable of fulfilling an SLA for the function.

13. The edge device of claim 1, wherein the operations further include to notify the remote edge device to execute the function, including an identification of a list of resources of the remote edge device to use for execution of the function.

14. The edge device of claim 1, wherein to select the remote edge device includes selecting a particular route of edge devices for sending data corresponding to the function to the remote edge device.

15. A method for using processing circuitry of an edge device of a system of edge devices, the method comprising:
identifying, at the edge device, a function to execute;
determining, for a plurality of remote edge devices of the system based on peer-to-peer communication among the edge device and the plurality of remote edge devices, a set of capabilities and constraints of each of the plurality of remote edge devices;
determining candidate remote edge devices from the plurality of remote edge devices based on function requirements for the function and the set of capabilities and constraints;
ranking the candidate remote edge devices according to an energy score for the system determined using the set of capabilities and constraints; and
selecting, from the ranked candidate remote edge devices, a top ranked remote edge device to execute the function.

16. The method of claim 15, wherein capabilities of the set of capabilities and constraints include resources offered at each of the plurality of remote edge devices.

17. The method of claim 15, wherein constraints of the set of capabilities and constraints include at least one of power availability, power source, or power reliability, at each of the plurality of remote edge devices.

18. The method of claim 15, wherein selecting the remote edge device includes identifying a number of hops to the remote edge device from the edge device, the number of hops fulfilling a number of hops requirement corresponding to the function.

19. The method of claim 15, wherein selecting the remote edge device includes determining a latency at the remote edge device, the latency fulfilling a latency requirement corresponding to the function.

20. The method of claim 15, wherein selecting the remote edge device includes receiving a power availability at the remote edge device.

21. The method of claim 15, wherein selecting the remote edge device includes receiving a resource availability at the remote edge device capable of executing the function.

22. The method of claim 15, wherein selecting the remote edge device includes using at least one of power available in each select of the candidate remote edge devices and a corresponding cost to the power available when executing the function, a latency between the edge device and each of the candidate remote edge devices, or a power cost of moving the function to each of the candidate remote edge devices.

23. An apparatus comprising:
means for identifying a function to execute;
means for determining, for a plurality of remote edge devices based on peer-to-peer communication among the apparatus and the plurality of remote edge devices, a set of capabilities and constraints of each of the plurality of remote edge devices;
means for determining candidate remote edge devices from the plurality of remote edge devices based on function requirements for the function and the set of capabilities and constraints;
means for ranking the candidate remote edge devices according to an energy score for the system determined using the set of capabilities and constraints; and
means for selecting, from the ranked candidate remote edge devices, a top ranked remote edge device to execute the function.

24. The apparatus of claim 23, wherein the means for selecting the remote edge device include means for selecting a particular route of edge devices for sending data corresponding to the function to the remote edge device.

25. At least one non-transitory machine-readable medium including instructions, which when deployed and executed by a processing circuitry of an edge device of a system of edge devices, cause the processing circuitry to:
identify a function to execute;
determine, for a plurality of remote edge devices of the system based on peer-to-peer communication among the edge device and the plurality of remote edge devices, a set of capabilities and constraints of each of the plurality of remote edge devices;
determine candidate remote edge devices from the plurality of remote edge devices based on function requirements for the function and the set of capabilities and constraints;
rank the candidate remote edge devices according to an energy score for the system determined using the set of capabilities and constraints; and
select, from the ranked candidate remote edge devices, a top ranked remote edge device to execute the function.
